(19) United States
(12) Patent Application Publication
(10) Pub. No.: US 2004/0239843 A1
(43) Pub. Date: Dec. 2, 2004

(54) Reflective-type liquid crystal display

(76) Inventors: Wen Jui Liao, Tai Ping City (TW); Yi-Chun Wu, Hualien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/449,021

(22) Filed: Jun. 2, 2003

(51) Int. Cl. G02F 1/1335

(52) U.S. Cl. 349/113

(57) ABSTRACT

A reflective-type liquid crystal display includes a display module having an upper basic layer, a lower basic layer and a liquid crystal layer sandwiched between the upper basic layer and the lower basic layer. A diffuser is piled upon the upper basic layer opposite to the liquid crystal layer and has a haze set from 20% to 60%. A reflective layer is disposed between the lower basic layer and the liquid crystal layer. The reflective layer includes multiple curvature reflective surfaces extending from a top surface of the reflective layer. Each curvature reflective surface reflects and guides the lights from different directions to a normal direction of the reflective-type liquid crystal display.

### BACKGROUND OF THE INVENTION

1. Field of the Invention

The present invention relates to a liquid crystal display, and more particularly to a reflective-type liquid crystal display that reflects the light of the surroundings and the reflective light rays each parallel to a normal of the liquid crystal display to promote the illumination of the liquid crystal display.

2. Description of Related Art

A conventional reflective-type liquid crystal display (9) in accordance with the prior art shown in FIG. 5 comprises a reflective board (91) and a diffuser film (92) corresponding to the reflective board (91) of the liquid crystal display. The light of the surroundings is diffused when passing through the diffuser film (92) and into the liquid crystal display. The reflective board (91) reflects the diffused light to make the diffused light passing through the diffuser film (92) to the outsides.

The above structure of the reflective-type liquid crystal display can prevent the liquid crystal display from causing a lens reflex that may lead to a dizzy light and a reflection of the outside objects. The number of the light rays, that are parallel to the normal of the liquid crystal, are reduced and lead to a unclear image and a bad contrast to the image that shown on the liquid crystal because the light of the surroundings passes the diffuser film (92) twice and is diffused twice.

For solving the above problem, with reference to FIG. 6, another reflective-type liquid crystal display is provided. In this embodiment, multiple inclined micro-mirrors (94) are disposed on the reflective board (93) to promote the light ray parallel to the normal of the reflective-type liquid crystal display.

However, to manufacture the inclined micro-mirrors (94) needs to use the very expensive process of gray-scale mask or repeatedly move the mask and exposure. Consequently, the manufacturing cost will become very high. Furthermore, each inclined micro-mirror only reflects the light from a certain direction. The using rate of the reflective board (93) is low that may reduce the brightness of the liquid crystal display.

The present invention has arisen to mitigate and/or obviate the disadvantages of the conventional reflective-type liquid crystal display.

### SUMMARY OF THE INVENTION

The main objective of the present invention is to provide an improved reflective-type liquid crystal display that has a better brightness in a normally direction relative to the conventional one.

To achieve the objective, the reflective-type liquid crystal display in accordance with the present invention comprises a display module having an upper basic layer, a lower basic layer and a liquid crystal layer sandwiched between the upper basic layer and the lower basic layer. A diffuser is piled upon the upper basic layer opposite to the liquid crystal layer and has a haze set from 20% to 60%. A reflective layer is disposed between the lower basic layer and the liquid crystal layer. The reflective layer includes multiple curvature reflective surfaces extending from a top surface of the reflective layer. Each curvature reflective surface reflects and guides the lights from different directions to a normal direction of the reflective-type liquid crystal display.

Further benefits and advantages of the present invention will become apparent after a careful reading of the detailed description with appropriate reference to the accompanying drawings.

### BRIEF DESCRIPTION OF THE DRAWINGS

FIG. 1 is a cross-sectional view of a reflective-type liquid crystal display in accordance with the present invention;

FIG. 2 is a perspective view of a lower basic layer and a reflective layer of the reflective-type liquid crystal display in FIG. 1, wherein the reflective layer is piled up the lower basic layer;

FIG. 3 is a partially operational plan view of the reflective layer in FIG. 2;

FIG. 4 is an operational view in cross-section of the reflective-type liquid crystal display in FIG. 1;

FIG. 5 is an operational view in cross-section of a conventional reflective-type liquid crystal display in accordance with the present invention; and

FIG. 6 is cross-sectional view of a reflective layer of another conventional reflective-type liquid crystal display in accordance with the present invention.

### DETAILED DESCRIPTION OF THE INVENTION

Referring to the drawings and initially to FIGS. 1-3, a reflective-type liquid crystal display in accordance with the present invention comprises a display module (1) including an upper basic layer (11), a lower basic layer (12) and a liquid crystal layer (13) sandwiched between the upper basic layer (11) and the lower basic layer (12). The lower basic layer (12) includes multiple curvature costate stripe (121) extending toward the liquid crystal layer (13).

A reflective layer (14) is disposed between the lower basic layer (12) and the liquid crystal layer (13). Multiple curvature reflective surfaces (141) are formed on the reflective layer (14) and each has a shape corresponding to that of a corresponding one of the curvature costate stripes (121). The curvature reflective surface (141) reflects and guides the light to a normal direction (A) of the reflective-type liquid crystal display.

A diffuser film (2) is piled upon the upper basic layer (11) opposite to the liquid crystal layer (13). The diffuser film (2) has a haze set from 20% to 60%. After seriously researching, the reflective-type liquid crystal display has a best brightness when the haze is 40%. Furthermore, each curvature costate stripe (121) has a width relative to the haze of the diffuser film (2).

In the preferred embodiment of the present invention, the reflective-type liquid crystal display further comprises a retardation film (31) and an upper polarizer (32) sequentially piled upon the diffuser film (2). A ¼ λ film (33) and a lower polarizer (34) are sequentially attached to a bottom of the lower basic layer (12).

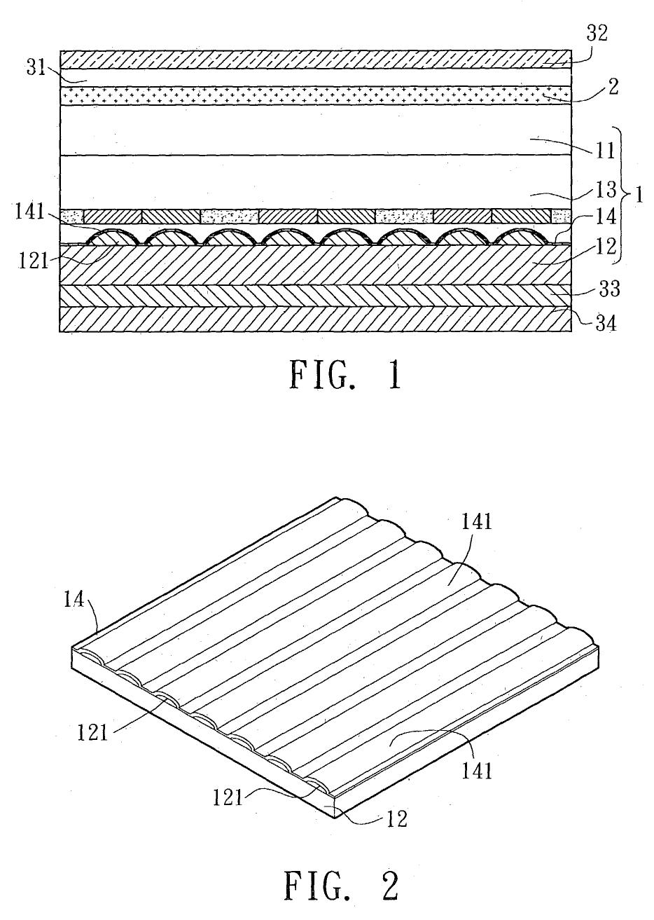

With reference to FIG. 2, a method of manufacturing the curvature reflective surface comprises the following steps:

1. The top surface of the lower basic layer (12) is coated by photo-resist.

2. Multiple curvature costate stripes (121) is formed on the top surface of the lower basic layer (12) after the coated lower basic layer (12) has finished the processes of photolithography, development and reflowing. The multiple curvature costate stripes (121) are parallel to one another.

3. The reflective layer (14) is coated on the top surface of the lower basic layer (12) to form multiple curvature reflective surfaces (141). Consequently, each curvature reflective surface (141) has a shape corresponding to one of the multiple curvature costate stripes (121).

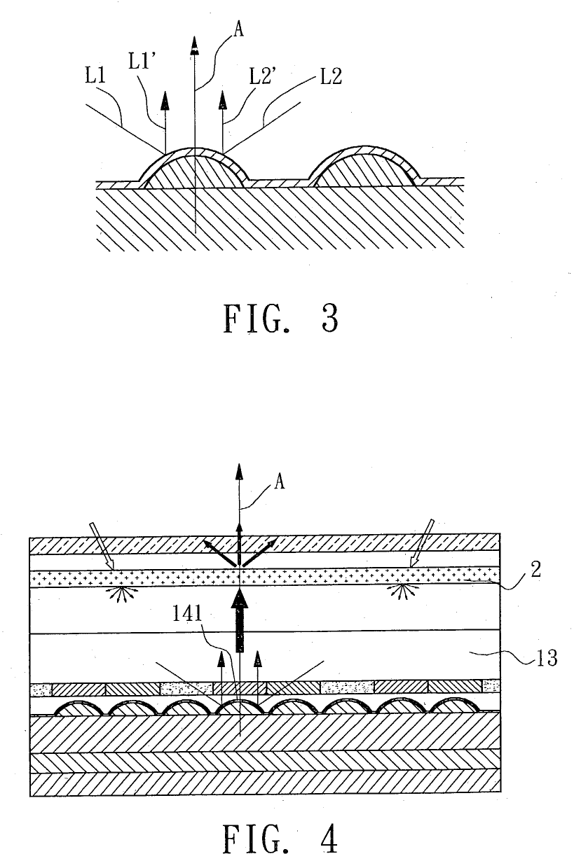

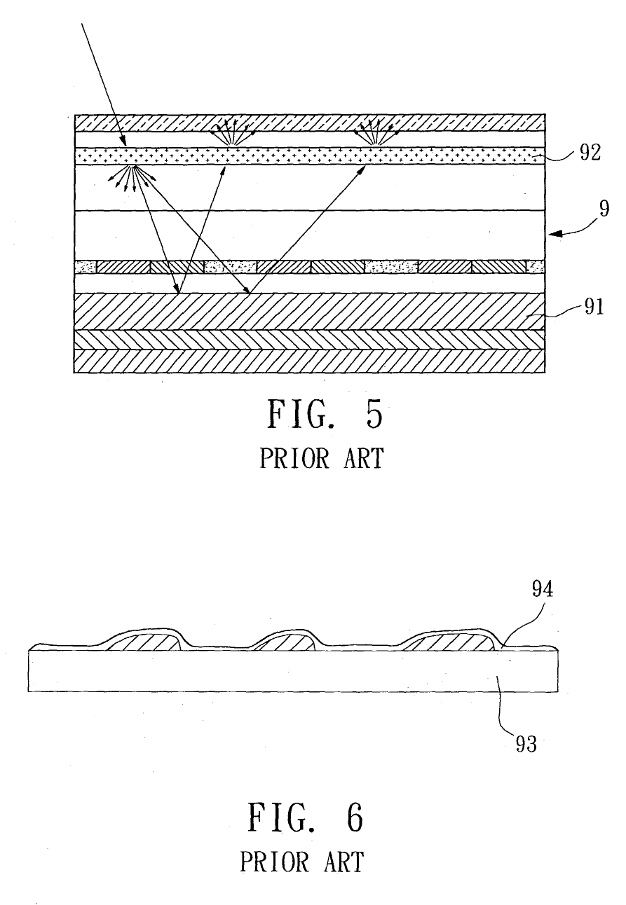

As described above, the diffuser film (12) is provided to prevent the reflective-type liquid crystal display from causing a lens reflex. With reference to FIGS. 3 and 4, the lights (L1, L2) from different directions are reflected to lights (L1′ and L2′) that are parallel to the normal direction (A) of the reflective-type liquid crystal display due to the spherical periphery of each of the curvature reflective surfaces (141). Consequently, the using rate of the reflected lights is promoted and the reflective-type liquid crystal display has a better brightness than the conventional one.

The diffuser film (12) has a suitable haze and is co-operated to the multiple curvature reflective surfaces (141) of each of the curvature costate stripes (14). The reflected lights are parallel to the normal of the reflective-type liquid crystal display such that the using rate of the reflected light is promote and the normally view of the reflective-type liquid crystal display of the present invention has a better brightness than that of the conventional liquid crystal display.

Although the invention has been explained in relation to its preferred embodiment, it is to be understood that many other possible modifications and variations can be made without departing from the spirit and scope of the invention as hereinafter claimed.

What is claimed is:

1. A reflective-type liquid crystal display comprising:
a display module including an upper basic layer, a lower basic layer and a liquid crystal layer sandwiched between the upper basic layer and the lower basic layer;
a diffuser piled upon the upper basic layer opposite to the liquid crystal layer and having a haze set from 20% to 60%; and
a reflective layer disposed between the lower basic layer and the liquid crystal layer, the reflective layer including multiple curvature reflective surfaces extending from a top surface of the reflective layer, each curvature reflective surface reflecting and guiding the lights from different directions to a normal direction of the reflective-type liquid crystal display.

2. The reflective-type liquid crystal display as claimed in claim 1, wherein the haze of the diffuser film is 40%.
